(19) United States
(12) Patent Application Publication
(10) Pub. No.: US 2016/0009198 A1
(43) Pub. Date: Jan. 14, 2016

(54) VEHICLE SEAT LOCKING DEVICE

(71) Applicant: AISIN SEIKI KABUSHIKI KAISHA, Kariya-shi (JP)

(72) Inventors: Daishi YAGUCHI, Obu-shi (JP); Kazuya IWASA, Obu-shi (JP)

(73) Assignee: AISIN SEIKI KABUSHIKI KAISHA, Kariya-shi (JP)

(21) Appl. No.: 14/740,666

(22) Filed: Jun. 16, 2015

(30) Foreign Application Priority Data
Jul. 8, 2014 (JP) 2014-140376
Apr. 15, 2015 (JP) 2015-083557

(51) Int. Cl. B60N 2/015

(52) U.S. Cl. CPC B60N 2/015

(57) ABSTRACT

A vehicle seat locking device includes: a base member having a base groove into which a striker fixed to one of fixed and movable members is inserted, and fixed to the other of the and movable members; a latch having a latch groove engageable with and disengageable from the striker, rotatably attached to the base member, and rotatable between a locked position and an unlocked position; and a cam pawl attached to the base member, rotatable between an allowable position and a preventive position and rotating from the preventive position to the allowable position when a locking release operation is performed, wherein the cam pawl has a restricting surface restricting the rotation of the latch, and a cam surface rotating in a direction toward the preventive position, coming into contact with the contact surface, rotating the latch, and restricting the rotation of the latch.

### CROSS REFERENCE TO RELATED APPLICATIONS

This application is based on and claims priority under 35 U.S.C. §119 to Japanese Patent Applications 2014-140376 and 2015-083557, filed on Jul. 8, 2014 and Apr. 15, 2015, respectively, the entire contents of which are incorporated herein by reference.

### TECHNICAL FIELD

This disclosure relates to a vehicle seat locking device.

### BACKGROUND DISCUSSION

A vehicle seat locking device for engageably and disengageably fixing a vehicle seat to a vehicle body is known. The vehicle seat locking device restrains a striker fixed to the vehicle body using a latch.

For example, a vehicle seat locking device may include a base member attached to a seat; a latch that is rotatably attached to the base member; a cam that is engaged with the latch; and a pawl (for example, refer to JP2012-179962A (Reference 1)).

A base groove is formed in the base member. The latch restrains the striker inserted into the base groove by rotating to a locked position. The pawl restricts the rotation of the latch such that the latch is maintained at the locked position. When the latch is at the locked position, the cam rotates the latch further toward the locked position. The vehicle seat locking device restrains the striker in the base groove by virtue of the action of each of these components.

There has been demand for reduction in size of the vehicle seat locking device. However, since there is limitation to the possible reduction in size of configuration components in the structure of the vehicle seat locking device in the related art for reasons of strength, it is difficult to further reduce the size of the vehicle seat locking device.

### SUMMARY

Thus, a need exists for a vehicle seat locking device which is not suspectable to the drawback mentioned above.

An aspect of this disclosure is directed to a vehicle seat locking device including: a base member that has a base groove into which a striker fixed to one of a fixed member and a movable member is inserted, and is fixed to the other of the fixed member and the movable member; a latch that has a latch groove which can be engaged with and disengaged from the striker, is rotatably attached to the base member, and can rotate between a locked position, at which the latch restrains the striker in the base groove, and an unlocked position at which the latch releases the striker; and a cam pawl that is attached to the base member, can rotate between an allowable position, at which the cam pawl allows the latch to rotate between the locked position and the unlocked position, and a preventive position, at which the cam pawl prevents the rotation of the latch from the locked position to the unlocked position, and rotates from the preventive position to the allowable position when a locking release operation is performed. The cam pawl has a restricting surface that restricts the rotation of the latch in a direction toward the unlocked position by coming into contact with a contact surface of the latch, and a cam surface that rotates in a direction toward the preventive position, comes into contact with the contact surface as the latch rotates in the direction toward the locked position, rotates the latch in the direction toward the locked position, and restricts the rotation of the latch in the direction toward the unlocked position, and both the restricting surface and the cam surface are formed on the same circumferential surface.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a rear seat of an embodiment;

FIG. 2 is a schematic view of a seat locking device in an intermediate state;

FIG. 3 is an enlarged view of portion A in FIG. 2;

FIG. 4 is a schematic view of the seat locking device immediately after locking is released;

FIG. 5 is a schematic view of the seat locking device when locking is released;

FIG. 6 is a schematic view of the seat locking device in an unlocked state;

FIG. 7 is a schematic view of the seat locking device in a locked state;

FIG. 8 is a schematic view of the seat locking device in the locked state;

FIG. 9 is an enlarged view of a cam pawl in a modification example of the seat locking device; and

FIGS. 10A to 10D are enlarged views of a contact portion between a latch and the cam pawl in the modification example of the seat locking device.

### DETAILED DESCRIPTION

A vehicle seat locking device of an embodiment, mounted on a vehicle rear seat, will be described.

A rear seat (movable member) 10, which moves relative to a vehicle body (fixed member), is restrained at a predetermined position by the vehicle seat locking device.

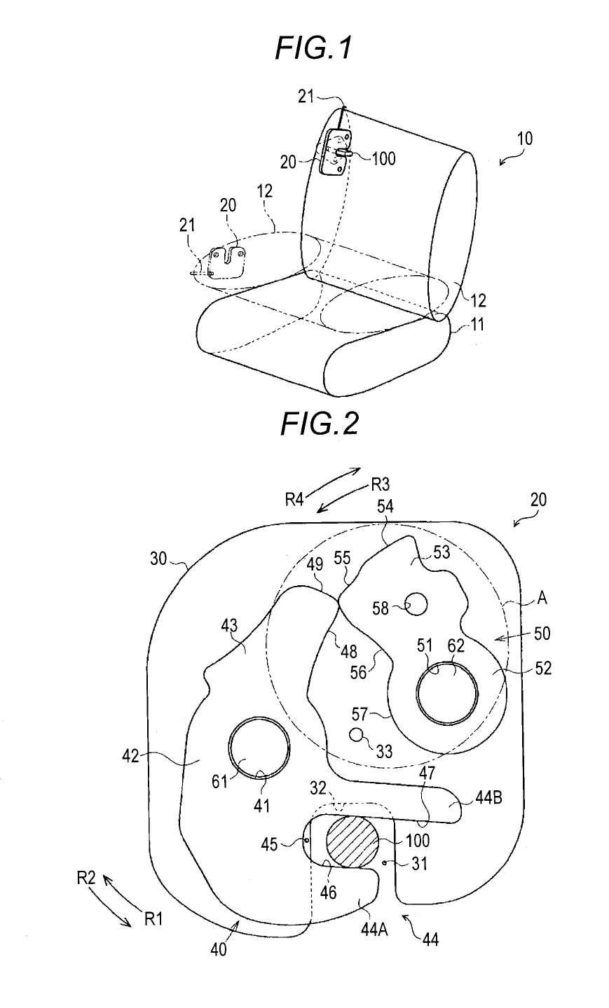

FIG. 1 illustrates the rear seat 10 to which the vehicle seat locking device (hereinafter, referred to as a seat locking device 20) is attached.

The rear seat 10 has a seat cushion 11 and a seatback 12. The seatback 12 can rotate relative to the seat cushion 11. The position of the seatback 12 illustrated by the alternating long and two short dashes line in FIG. 1 represents the position of the seatback 12 in a forward folded state.

The seat locking device 20 is attached to a side surface of the seatback 12. An operating lever 21 is attached to the seat locking device 20. A locked state (refer to a description to be given hereinafter) of the seat locking device 20 is released by the operation of the lever 21.

A striker 100 is fixed to a vehicle body (fixed member), and is engaged with the seat locking device 20. The striker 100 is installed at a position corresponding to the position of disposition of the seat locking device 20 when the seatback 12 stands upright.

When the seatback 12 stands upright, the seat locking device 20 restrains the striker 100. Therefore, the seatback 12 is fixed in an upright standing posture. In the description given hereinbelow, the “locked state” refers to a state in which the seat locking device 20 restrains the striker 100.

The locked state of the seat locking device 20 is released by the operation of the lever 21. When the locking of the seat locking device 20 is released, the seat locking device 20 and the striker 100 can move away from each other. At this time, the seatback 12 can transition from the upright standing posture to a forward folded posture. In the description given hereinbelow, an “unlocked state” refers to a state in which the seat locking device 20 has released the striker 100.

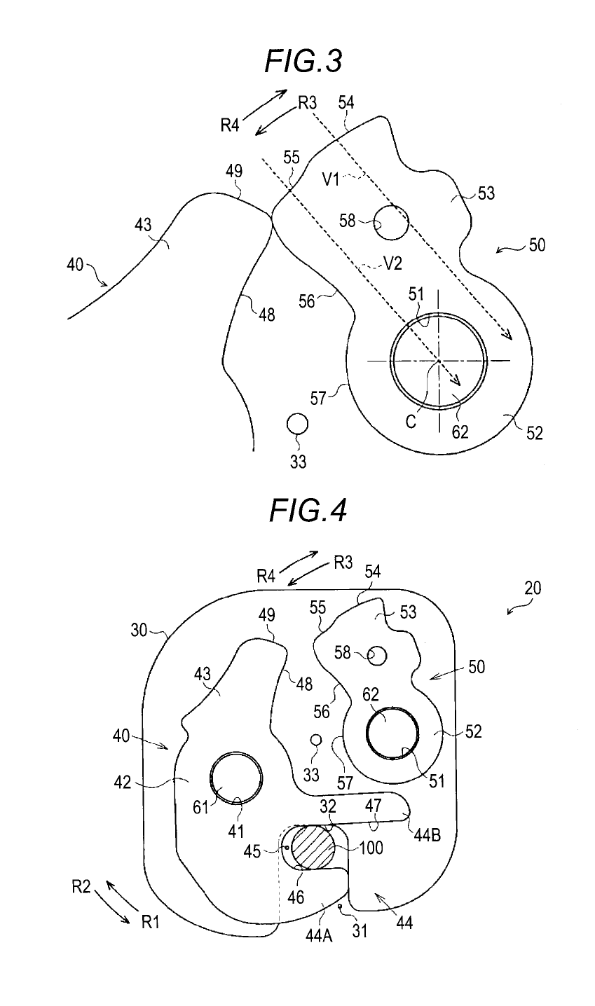

The configuration of the seat locking device 20 will be described with reference to FIGS. 2 and 3.

As illustrated in FIG. 2, the seat locking device 20 includes a base member 30; a latch 40; a cam pawl 50; a latch shaft 61 that is the rotary shaft of the latch 40; and a cam pawl shaft 62 that is the rotary shaft of the cam pawl 50. The seat locking device 20 includes a first elastic member and a second elastic member (not illustrated).

A base groove 31 is formed in the base member 30. The base groove 31 is formed in a movement locus of the seatback 12 when transitioning from the forward folded posture to the upright standing posture, and has an orientation facing the striker 100. Accordingly, when the seatback 12 transitions from the forward folded posture to the upright standing posture, the striker 100 is inserted into the base groove 31.

The latch 40 and the cam pawl 50 are rotatably disposed on the base member 30. A protrusion 33 is provided on the base member 30, such that the protrusion 33 restricts the further rotation of the latch 40 in a first rotational direction R1 (refer to an arrow R1 in FIG. 6) by coming into contact with the latch 40 in the unlocked state.

The latch 40 is formed in the shape of a plate.

The latch 40 has a bearing portion 42; a first protruding portion 43 that protrudes from the bearing portion 42; and a second protruding portion 44 that protrudes from the bearing portion 42 in a direction different from a protruding direction of the first protruding portion 43.

A latch groove 45 is formed at a distal end of the second protruding portion 44.

For example, the second protruding portion 44 is made up of a groove lower portion 44A and a groove upper portion 44B, and the latch groove 45 is provided between the groove lower portion 44A and the groove upper portion 44B.

A side surface, adjacent to the latch groove 45, of the groove lower portion 44A forms one side surface (hereinafter, referred to as a “groove lower surface 46”) of the latch groove 45. A side surface, adjacent to the latch groove 45, of the groove upper portion 44B forms the other side surface (hereinafter, referred to as a “groove upper surface 47”) of the latch groove 45. The width (size of a gap between the groove lower surface 46 and the groove upper surface 47) of the latch groove 45 is slightly greater than the diameter of the striker 100.

The length of the groove upper portion 44B is greater than that of the groove lower portion 44A. That is, an opening portion of the latch groove 45 is enlarged to be larger than the width of the latch groove 45. For this reason, the striker 100 is easily inserted into the latch groove 45.

The latch groove 45 is formed in the latch 40 in such a manner that the movement locus of the latch groove 45 passes over the base groove 31 when the latch 40 rotates.

That is, as illustrated in FIGS. 4 to 8, at least a portion of the latch groove 45 overlaps the base groove 31 of the base member 30 when the rotating latch 40 is seen in an axial direction of the latch shaft 61.

The first protruding portion 43 has a side surface (hereinafter, referred to as a “contact surface 48”) that comes into contact with a cam surface 54 and a restricting surface 55 (refer to FIG. 3) of the cam pawl 50, and an end surface (hereinafter, referred to as a “contact surface 49”) that is radially oriented toward the outside, and comes into contact with a preventive surface 56 of the cam pawl 50. The contact surface 49 is formed at a distal end of the first protruding portion 43.

A shaft hole 41 is formed in the bearing portion 42 of the latch 40, and has a diameter slightly larger than that of the latch shaft 61. The latch shaft 61 is inserted into the shaft hole 41, and the latch 40 can rotate around the latch shaft 61. The latch 40 is attached to the base member 30 in such a manner that the latch 40 can rotate around the latch shaft 61 as a rotary shaft relative to the base member 30.

The latch 40 rotates in a range between a locked position to an unlocked position. The locked position represents the position of the latch 40 when restraining the striker 100 in the latch groove 45 and the base groove 31. The unlocked position represents the position of the latch 40 when releasing the striker 100 from the base groove 31.

The first elastic member biases the latch 40 in a rotational direction (hereinafter, referred to as the “first rotational direction R1”) from the locked position to the unlocked position. In other words, the first elastic member biases the latch 40 in a direction in which the first protruding portion 43 of the latch 40 approaches the cam pawl 50. For example, the first elastic member is configured as a torsion coil spring. In this case, one end portion of the torsion coil spring is fixed to the base member 30, and the other end portion of the torsion coil spring is fixed to the latch 40.

The operation of the latch 40 will be described hereinbelow.

When the striker 100 is inserted into the latch groove 45, and pushes the side surface (the groove upper surface 47) of the latch groove 45 of the latch 40, the latch 40 rotates in a second rotational direction R2 while counteracting the biasing force of the first elastic member. When the striker 100 escapes from the latch groove 45, the biasing force of the first elastic member causes the latch 40 to rotate in the first rotational direction R1.

Subsequently, the cam pawl 50 will be described.

The cam pawl 50 is formed in the shape of a plate.

The cam pawl 50 is disposed on one surface (the surface on which the latch 40 is disposed) of the base member 30. That is, the cam pawl 50 and the latch 40 are disposed at the same position relative to the base member 30 in an axial direction of the cam pawl shaft 62. The latch 40 and the cam pawl 50 are separated from each other by a predetermined distance, and the rotation of either one of or both the latch 40 and the cam pawl 50 brings the latch 40 and the cam pawl 50 into contact with each other.

The cam pawl 50 has a bearing portion 52, and a protruding portion 53 that protrudes from the bearing portion 52.

A shaft hole 51 is formed in the bearing portion 52 of the cam pawl 50, and has a diameter slightly larger than that of the cam pawl shaft 62. The cam pawl shaft 62 is inserted into the shaft hole 51, and the cam pawl 50 can rotate around the cam pawl shaft 62. The cam pawl 50 is attached to the base member 30 in such a manner that the cam pawl 50 can rotate around the cam pawl shaft 62 as a rotary shaft relative to the base member 30.

The cam pawl 50 rotates in a range between a preventive position and an allowable position. The preventive position represents the position of the cam pawl 50 when being engaged with the latch 40 at the locked position, and restricting the rotation of the latch 40 to the unlocked position. The allowable position represents the position of the cam pawl 50 when allowing the latch 40 to rotate between the locked position and the unlocked position.

As illustrated in FIG. 3, the protruding portion 53 of the cam pawl 50 has a side surface (hereinafter, referred to as the “preventive surface 56”) that comes into contact with a contact surface 49 of the latch 40, and two types of end surface (hereinafter, one is referred to as a “cam surface 54”, and the other as the “restricting surface 55”) that are radially oriented toward the outside, and come into contact with the contact surface 48 of the latch 40. The cam surface 54 and the restricting surface 55 are formed on the same circumferential surface of the cam pawl 50.

The cam surface 54 and the restricting surface 55 are provided adjacent to each other, and positioned sequentially in a circumferential direction. The restricting surface 55 is disposed inward than the cam surface 54 (the restricting surface 55 is closer to the latch 40 than the cam surface 54 is). The cam surface 54 is disposed in such a manner as to be further outward from the cam pawl shaft 62 than the restricting surface 55 in a radial direction.

The cam surface 54 is formed in such a manner that the distance between the cam surface 54 and a central axis C (that is, the central axis (central axis of rotation) of the cam pawl 50) of the cam pawl shaft 62 gradually increases in a fourth rotational direction R4 (the opposite direction to a third rotational direction R3 to be described later). That is, a normal line V1 drawn from approximately the center of the cam surface 54 is offset from the cam pawl shaft 62.

The restricting surface 55 is formed along a circular arched surface centered around the central axis C (that is, the central axis (central axis of rotation) of the cam pawl 50) of the cam pawl shaft 62. That is, a normal line V2 drawn from approximately the center of the restricting surface 55 runs toward the cam pawl shaft 62.

A small hole 58 is provided in the protruding portion 53 of the cam pawl 50. One end portion of the lever 21 is connected to the small hole 58. That is, the cam pawl 50 is rotated by the operation of the lever 21. The bearing portion 52 of the cam pawl 50 has a circumferential surface 57 formed along the circumference that is separated from the central axis C of the cam pawl shaft 62 by a predetermined distance.

The second elastic member biases the cam pawl 50 in a rotational direction (hereinafter, referred to as the “third rotational direction R3”) from the allowable position to the preventive position. In other words, the second elastic member biases the cam pawl 50 in a direction in which the protruding portion 53 of the cam pawl 50 approaches the latch 40. For example, the second elastic member is configured as a torsion coil spring. In this case, one end portion of the torsion coil spring is fixed to the base member 30, and the other end portion of the torsion coil spring is fixed to the cam pawl 50.

Subsequently, the action of the seat locking device 20 of the embodiment will be described.

First, the operation of the seat locking device 20, when the striker 100 is released, is described.

FIG. 4 illustrates a schematic view of the seat locking device 20 immediately after locking is released.

FIG. 4 illustrates the seat locking device 20 when the lever 21 is operated in a direction (hereinafter, referred to as a “locking release direction”) in which the striker 100 is separated from the seat locking device 20.

When the lever 21 is operated in the locking release direction, the cam pawl 50 rotates in the fourth rotational direction R4 while counteracting the biasing force of the second elastic member.

When the protruding portion 53 of the cam pawl 50 moves to a position (that is, the allowable position) at which the protruding portion 53 is not in contact with the first protruding portion 43 of the latch 40, a restriction on the rotation (refer to a description to be given hereinafter) of the latch 40 in the first rotational direction R1 is released. For this reason, the latch 40 rotates in the first rotational direction R1. As a result, the locked state, in which the seat locking device 20 restrains the striker 100, is released.

When the seatback 12 is folded forward, and thus the seat locking device 20 moves away from the striker 100, the striker 100 comes into contact with the groove lower surface 46 of the latch groove 45 of the latch 40, and thus the latch 40 rotates in the first rotational direction R1.

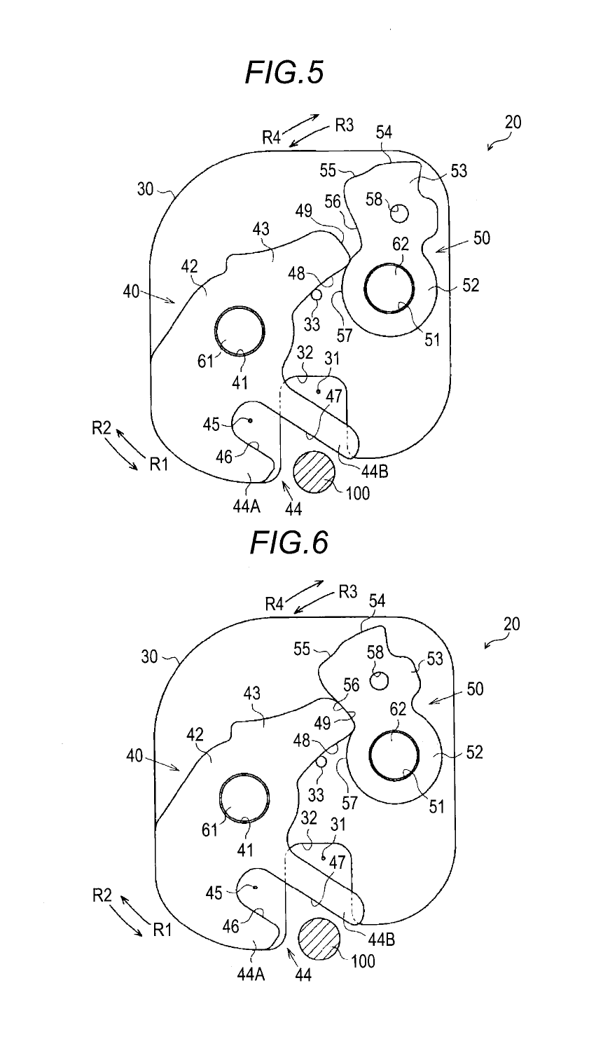

FIG. 5 illustrates a schematic view of the seat locking device 20 when locking is released.

When the latch 40 rotates in the first rotational direction R1, the latch 40 comes into contact with the protrusion 33 of the base member 30. Therefore, the further rotation of the latch 40 in the first rotational direction R1 is restricted. At this time, the opening portion of the latch groove 45 of the latch 40 is positioned in an opening portion of the base groove 31. As a result, the seat locking device 20 releases the striker 100.

The operation of the seat locking device 20, when transitioning to the unlocked state in a state where the striker 100 is released, will be described with reference to FIG. 6.

FIG. 6 illustrates the seat locking device 20 in the unlocked state.

When the operation of the lever 21 in the locking release direction is stopped, the biasing force of the second elastic member causes the cam pawl 50 to rotate in the third rotational direction R3. When the cam pawl 50 rotates, the latch 40 is in contact with the protrusion 33 of the base member 30. When the cam pawl 50 rotates to a predetermined position, the preventive surface 56 of the cam pawl 50 and the contact surface 49 of the latch 40 come into contact with each other. As a result, the unlocked state of the seat locking device 20 is formed.

When the seat locking device 20 is in the unlocked state, the preventive surface 56 of the cam pawl 50 is in contact with the contact surface 49 of the first protruding portion 43 of the latch 40, and thus the rotation of the cam pawl 50 is restricted. Since the latch 40 is in contact with the protrusion 33 of the base member 30, the rotation of the latch 40 is restricted. As a result, the unlocked state of the seat locking device 20 is stably maintained.

When the unlocked state of the seat locking device 20 is maintained, the opening portion of the latch groove 45 is positioned in the opening portion of the base groove 31, and the groove upper portion 44B of the latch 40 intersects the base groove 31.

When the seat locking device 20 approaches the striker 100, this disposition allows the striker 100 to smoothly enter both the base groove 31 of the base member 30 and the latch groove 45 of the latch 40. That is, when the striker 100 enters the base groove 31, naturally, the striker 100 comes into contact with the groove upper portion 44B, the latch 40 rotates in the second rotational direction R2, and the striker 100 is guided to a deep point in the base groove 31.

Subsequently, the operation of the seat locking device 20, when the striker 100 enters the seat locking device 20, will be described with reference to FIGS. 2, 7, and 8.

When the striker 100 enters the base groove 31 of the base member 30 in the seat locking device 20 in the unlocked state, the striker 100 comes into contact with the groove upper surface 47 of the groove upper portion 44B of the latch 40. For this reason, the groove upper portion 44B is pressed by the striker 100, and thus the latch 40 rotates in the second rotational direction R2 while counteracting the biasing force of the first elastic member, and the pressing force of the cam pawl 50 induced by the second elastic member. At this time, the first protruding portion 43 of the latch 40 moves while sliding against the preventive surface 56 of the cam pawl 50.

As illustrated in FIG. 2, when the latch 40 rotates further, a distal end angled portion (angled portion positioned in the first rotational direction R1) of the first protruding portion 43 of the latch 40 reaches an end portion of the preventive surface 56 (radial outer end portion of the preventive surface 56) of the protruding portion 53 of the cam pawl 50.

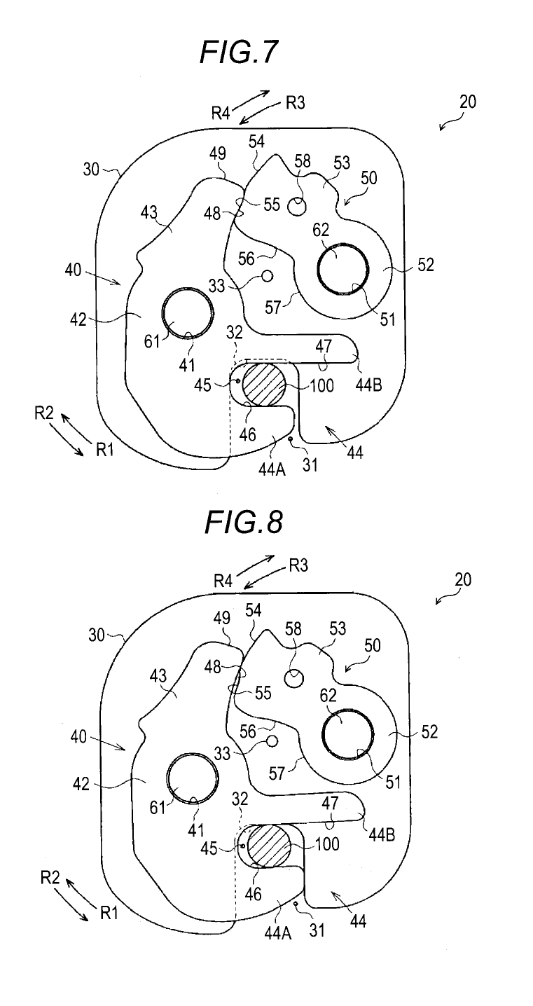

When the latch 40 rotates further in the second rotational direction R2 in such a state (intermediate state) of the seat locking device 20, the first protruding portion 43 of the latch 40 is disposed outward (outward in the radial direction) than the protruding portion 53 of the cam pawl 50, and the rotation of the cam pawl 50 in the third rotational direction R3 (biasing direction) is allowed. For this reason, the cam pawl 50 rotates in the third rotational direction R3. A distal end of the protruding portion 53 of the cam pawl 50 comes into contact with the contact surface 48 of the first protruding portion 43 of the latch 40. At this time, the restricting surface 55 of the protruding portion 53 of the cam pawl 50 comes into contact with the contact surface 48 of the first protruding portion 43 of the latch 40 (the cam pawl 50 is at a first preventive position at this time) (refer to FIG. 7). Therefore, the rotation of the latch 40 in the first rotational direction R1 is restricted. That is, the locked state of the seat locking device 20 is formed.

When the striker 100 enters the base groove 31 more deeply, and thus the latch 40 rotates in the second rotational direction R2, the gap between the first protruding portion 43 of the latch 40 and the protruding portion 53 of the cam pawl 50 (that is, between the contact surface 48 and the restricting surface 55) is formed, and thus the biasing force of the second elastic member causes the cam pawl 50 to rotate further in the third rotational direction R3.

As a result, as illustrated in FIG. 8, the cam surface 54 of the protruding portion 53 of the cam pawl 50 comes into contact with the contact surface 48 of the first protruding portion 43 of the latch 40 (the cam pawl 50 is at a second preventive position at this time).

When the striker 100 enters the base groove 31 more deeply, the latch 40 rotates in the second rotational direction R2, and thus the gap between the first protruding portion 43 of the latch 40 and the protruding portion 53 of the cam pawl 50 increases. As a result, the cam pawl 50 rotates further in the third rotational direction R3. Since the cam surface 54 of the cam pawl 50 is formed in such a manner that the distance between the cam surface 54 and the central axis of the cam pawl shaft 62 gradually increases in the fourth rotational direction R4, when the cam pawl 50 rotates in the third rotational direction R3, the gap between the first protruding portion 43 of the latch 40 and the protruding portion 53 of the cam pawl 50 is eliminated. Since the second elastic member biases the cam pawl 50 to rotate in the third rotational direction R3, the latch 40 is pressed in the second rotational direction R2 by a pressing force (force pressing the first protruding portion 43) induced by the rotation of the cam pawl 50 in the third rotational direction R3. As a result, even if the striker 100 enters the base groove 31 deeply, and thus the latch 40 rotates, contact between the first protruding portion 43 of the latch 40 and the protruding portion 53 of the cam pawl 50 is maintained. That is, engagement between the first protruding portion 43 of the latch 40 and the protruding portion 53 of the cam pawl 50 is maintained, and the locked state of the seat locking device 20 is maintained.

When the striker 100 enters the base groove 31 more deeply, the striker 100 comes into contact with a groove bottom portion 32 of the base groove 31. At this time, since the latch 40 is biased in the second rotational direction R2 by the rotation of the cam pawl 50 caused by the biasing force of the second elastic member, the groove lower portion 44A of the latch 40 presses the striker 100 to a deep point in the base groove 31. That is, the striker 100 is interposed between the groove bottom portion 32 of the base groove 31 of the base member 30 and the groove lower portion 44A of the latch 40. As a result, the striker 100 is restrained without being rattled by the seat locking device 20.

As described above, the locked state of the seat locking device 20 is maintained regardless of the movement of the striker 100. Specifically, the locked state of the seat locking device 20 is maintained in a range between a state (refer to FIG. 7) in which the restricting surface 55 of the protruding portion 53 of the cam pawl 50 is in contact with the contact surface 48 of the first protruding portion 43 of the latch 40 and a state (refer to FIG. 8) in which the cam surface 54 of the protruding portion 53 of the cam pawl 50 is in contact with the contact surface 48 of the first protruding portion 43 of the latch 40.

A description given hereinbelow relates to the operation of the seat locking device 20 when the base groove 31 and the striker 100 move away from each other in a state where the seat locking device 20 restrains the striker 100.

When the seat locking device 20 restrains the striker 100, the seat locking device 20 may move away from the striker 100. For example, when the seatback 12 is pushed in a forward direction, the seat locking device 20 moves away from the striker 100. In this case, since the striker 100 presses the groove lower portion 44A of the latch 40, a force rotating the latch 40 in the first rotational direction R1 is applied to the latch 40. In contrast, the rotation of the latch 40 in the first rotational direction R1 is restricted by engagement between the contact surface 48 of the latch 40 and the protruding portion 53 of the cam pawl 50. For this reason, even if a force rotating the latch 40 in the first rotational direction R1 is applied to the latch 40, insofar as the force is not considerably large, the rotation of the latch 40 is restricted, and the restraint of the striker 100 is maintained.

A force rotating the latch 40 in the first rotational direction R1 may be considerably large. For example, when a vehicle is suddenly stopped, a passenger seated in the rear seat 10 is moved forward due to inertia, and a force folding the seatback 12 forward is applied to the seatback 12 via a seat belt. At this time, the seat locking device 20 moves away from the striker 100, and the striker 100 presses the groove lower portion 44A of the latch 40 using a large load. For this reason, a large load rotating the latch 40 in the first rotational direction R1 is applied to the latch 40.

When the large load rotating the latch 40 in the first rotational direction R1 is applied to the latch 40, the first protruding portion 43 of the latch 40 presses the cam surface 54 of the cam pawl 50 using a large load. Since the normal line V1 of the cam surface 54 is offset from the cam pawl shaft 62, a portion of the force applied to the cam surface 54 causes the cam pawl 50 to rotate in the fourth rotational direction R4. When this force becomes greater than the biasing force rotating the cam pawl 50 in the third rotational direction R3, the cam pawl 50 rotates in the fourth rotational direction R4. At this time, the cam pawl 50 rotates in the fourth rotational direction R4 while the cam surface 54 is in sliding contact with the contact surface 48 of the first protruding portion 43 of the latch 40. When the cam pawl 50 rotates in the fourth rotational direction R4, and the restricting surface 55 comes into contact with the contact surface 48 of the first protruding portion 43 of the latch 40 (refer to FIG. 7), the rotation of the cam pawl 50 in the fourth rotational direction R4 is re-restricted due to a phenomenon to be described hereinbelow.

When the restricting surface 55 of the cam pawl 50 comes into contact with the contact surface 48 of the first protruding portion 43 of the latch 40, the force of the first protruding portion 43 of the latch 40 is applied to the restricting surface 55 of the cam pawl 50 in a direction toward the cam pawl shaft 62. The reason for this is that the normal line V2 of the restricting surface 55 runs toward the cam pawl shaft 62 (refer to FIG. 3). For this reason, the force rotating the cam pawl 50 in the fourth rotational direction R4 is reduced, and thus the cam pawl 50 is prevented from rotating in the fourth rotational direction R4.

That is, in the locked state where the restricting surface 55 of the cam pawl 50 is in contact with the contact surface 48 of the first protruding portion 43 of the latch 40, almost all of the force rotating the latch 40 in the first rotational direction R1 is applied to the cam pawl shaft 62 via the first protruding portion 43 of the latch 40 and the protruding portion 53 of the cam pawl 50. For this reason, even if the force rotating the latch 40 in the first rotational direction R1 is large, the cam pawl 50 becomes prevented from rotating in the fourth rotational direction R4.

Also when a strong force separating the striker 100 from the base groove 31 is applied to the seat locking device 20, the striker 100 is restrained by the seat locking device 20.

The following is a summary of the aforementioned actions and operations of the seat locking device 20.

When the striker 100 enters the latch groove 45 of the latch 40, and the restricting surface 55 or the cam surface 54 of the cam pawl 50 comes into contact with the contact surface 48 of the latch 40, the rotation of the latch 40 relative to the base member 30 in the first rotational direction R1 is restricted. Therefore, the locked state of the seat locking device 20 is formed.

When the locked state is formed, and the cam pawl 50 is rotated in the fourth rotational direction R4 by the operation of the lever 21, the restricting surface 55 and the cam surface 54 of the cam pawl 50 do not come into contact with the contact surface 48 of the latch 40. When the seat locking device 20 moves away from the striker 100, the striker 100 pushes the groove lower portion 44A of the latch 40. Therefore, the latch 40 rotates relative to the base member 30 in the first rotational direction R1, and the striker 100 is separated from the latch groove 45. As a result, the restraint of the striker 100 by the latch 40 is released, and the unlocked state of the seat locking device 20 is formed.

When the unlocked state is formed, the position and the posture of the rear seat 10 can be changed. When the rear seat 10 returns from the changed position or posture to the original position or posture, the seat locking device 20 in the unlocked state is operated as follows.

When the striker 100 approaches the seat locking device 20, and comes into contact with the groove upper portion 44B of the latch 40, the groove upper portion 44B of the latch 40 pushes the striker 100, and the latch 40 rotates in the second rotational direction R2. Then, since the striker 100 enters the base groove 31 of the base member 30 and the latch groove 45 of the latch 40, the striker 100 is restrained by the base member 30 and the latch 40. When the contact surface 48 of the latch 40 comes into contact with the restricting surface 55 or the cam surface 54 of the cam pawl 50, the locked state is formed.

A large impact force may be applied to the rear seat 10 in the forward direction when a predetermined locked state (state in which the contact surface 48 of the latch 40 is in contact with the cam surface 54 of the cam pawl 50) is formed. In this case, since the seat locking device 20 moves away from the striker 100, a large load is applied to the latch 40 via the striker 100, and the latch 40 rotates. Therefore, the cam pawl 50 rotates in the fourth rotational direction R4. When this rotation progresses, the restraint of the rotation of the latch 40 caused by contact between the contact surface 48 of the latch 40 and the cam surface 54 of the cam pawl 50 is not maintained. When this rotation further progresses, the contact surface 48 of the latch 40 comes into contact with the restricting surface 55, formed to be closer in the third rotational direction R3 than the cam surface 54, instead of the cam surface 54, and thus the rotation of the latch 40 is re-restricted. Therefore, the restraint (locked state) of the striker 100 by the base member 30 and the latch 40 is maintained. As a result, even if a large impact force is applied to the rear seat 10, the seat locking device 20 can reliably restrain the striker 100.

Subsequently, the features of the seat locking device 20 will be described compared to a seat locking device with the structure in the related art.

The seat locking device with the structure in the related art includes the base member 30; the latch 40; a cam; and a pawl. The base groove 31 is provided in the base member 30. The latch 40 along with the base member 30 restrains the striker 100. The cam rotates the latch 40 to a locked position. The pawl restricts the rotation of the latch 40 so that the latch 40 can be maintained at the locked position. The vehicle seat locking device restrains the striker 100 by virtue of the action of each of these components. That is, in the seat locking device with the structure in the related art, the pawl and the cam separate from the pawl are provided as units that restrict the rotation of the latch 40 from the locked position.

In this type of seat locking device, since the components are required to reliably restrain the striker 100 by being engaged with each other, an engineer designs the shape of each component while taking manufacturing variation in the dimensions of each component into consideration. When an engineer designs each component while taking manufacturing dimensional variation and the maximum load applied to the seat locking device into consideration, naturally, the size of each component becomes greater than or equal to an adequate dimension. That is, it is not possible to simply reduce the size of each component in a similar manner. For this reason, there is limitation to the size reduction of the seat locking device with the structure in the related art.

In the seat locking device 20 illustrated in the embodiment, the cam pawl 50 works as both a cam and a pawl of the structure in the related art. For this reason, the number of components of the seat locking device 20 of the embodiment is less than that of the seat locking device with the structure in the related art. A space required to dispose each component can be reduced to the extent that the number of components is reduced. For this reason, even if the size of each component is not considerably reduced, it is possible to reduce the size of the seat locking device 20.

Specifically, in the seat locking device with the structure in the related art, in the axial direction of the latch shaft 61, the latch 40 and the pawl are disposed at the same position, and the cam is disposed while being offset from the position of the disposition of the latch 40 and the pawl. For this reason, the thickness of the seat locking device with the structure in the related art has a dimension that is obtained by adding together the thickness of the latch 40 (or the pawl), the thickness of the cam, and the thickness of the base member 30.

In contrast, in the seat locking device 20 of the embodiment, in the axial direction of the latch shaft 61, the latch 40 and the cam pawl 50 are disposed at the same position, and there are no components that are disposed while being offset from the latch 40 and the cam pawl 50. For this reason, the thickness of the seat locking device 20 has a dimension that is obtained by adding together the thickness of the latch 40 (or the cam pawl 50) and the thickness of the base member 30. As a result, it is possible to make the seat locking device 20 of the embodiment thin from the thickness of the seat locking device with the structure in the related art.

In the embodiment, it is possible to obtain the following effects.

(1) The seat locking device 20 includes the base member 30; the latch 40; and the cam pawl 50. The cam pawl 50 has the cam surface 54 and the restricting surface 55 which are formed on the same circumferential surface. The restricting surface 55 restricts the rotation of the latch 40 in the direction (the first rotational direction R1) toward the unlocked position by coming into contact with the contact surface 48 of the latch 40. Since the cam pawl 50 rotates in the direction (in the third rotational direction R3) toward the preventive position as the latch 40 rotates further in the direction toward the locked position, the cam surface 54 comes into contact with the contact surface 48. Therefore, the latch 40 rotates in the direction (the second rotational direction R2) toward the locked position, and the rotation of the latch 40 in the direction (the first rotational direction R1) toward the unlocked position is restricted.

In this configuration, the cam pawl 50 has both the function of restricting the rotation of the latch 40 in the direction (the first rotational direction R1) toward the unlocked position, and the function of rotating the latch 40 in the direction (the second rotational direction R2) toward the locked position. That is, the cam pawl 50 has the functions of both the cam and the pawl of the seat locking device with the structure in the related art. As a result, it is possible to reduce the number of components. That is, the seat locking device 20 can be configured to have a lower number of components than that of the vehicle seat locking device in the related art. For this reason, it is possible to reduce the size of the seat locking device 20 from that of the seat locking device with the structure in the related art.

(2) In the seat locking device 20, the latch 40 has the first protruding portion 43 that protrudes from the bearing portion 42, and the contact surface 48 is formed in a side portion of the first protruding portion 43. The cam pawl 50 has the protruding portion 53 that protrudes from the bearing portion 52, and the cam surface 54 and the restricting surface 55 are formed at the distal end of the protruding portion 53.

In this configuration, when the contact surface 48 of the side portion of the first protruding portion 43 of the latch 40 comes into contact with the cam surface 54 or the restricting surface 55 at the distal end of the protruding portion 53 of the cam pawl 50, the side portion of the first protruding portion 43 of the latch 40 is engaged with the distal end of the cam pawl 50, and thus the rotation of the latch 40 is restricted.

### Other Embodiments

As illustrated in FIG. 3, the seat locking device 20 of the embodiment is configured such that the restricting surface 55 of the cam pawl 50 is formed along the circular arched surface centered around the central axis C of the cam pawl shaft 62, and the normal line V2 drawn from approximately the center of the restricting surface 55 runs toward the cam pawl shaft 62. As a substitute for this configuration, the restricting surface 55 can have the following configuration.

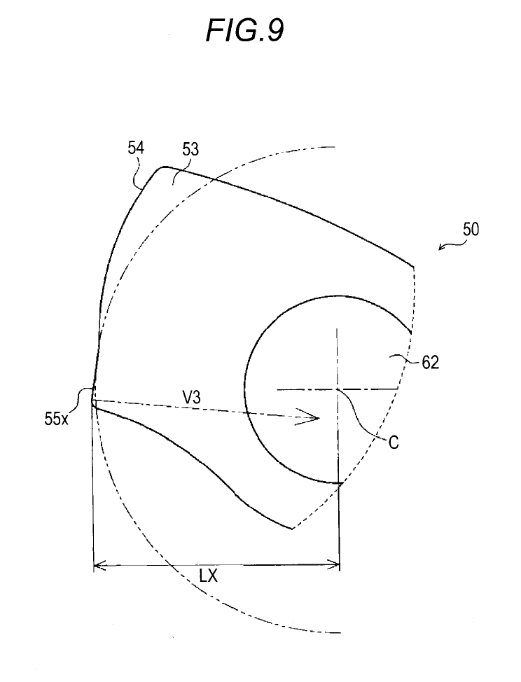

A modification example of the cam pawl 50 is described with reference to FIG. 9. The alternating long and two short dashes line in FIG. 9 represents a circle centered around the central axis C of the cam pawl shaft 62.

A restricting surface 55x is formed in such a manner that a distance LX between the restricting surface 55x and the central axis C (that is, the central axis (central axis of rotation) of the cam pawl 50) of the cam pawl shaft 62 gradually decreases in the fourth rotational direction R4. In other words, the restricting surface 55x is configured such that the distance LX between the restricting surface 55x and the central axis C of the cam pawl shaft 62 gradually increases toward the latch 40. In this case, a normal line V3 drawn from approximately the center of the restricting surface 55x is offset from the center of the cam pawl shaft 62 toward the latch shaft 61.

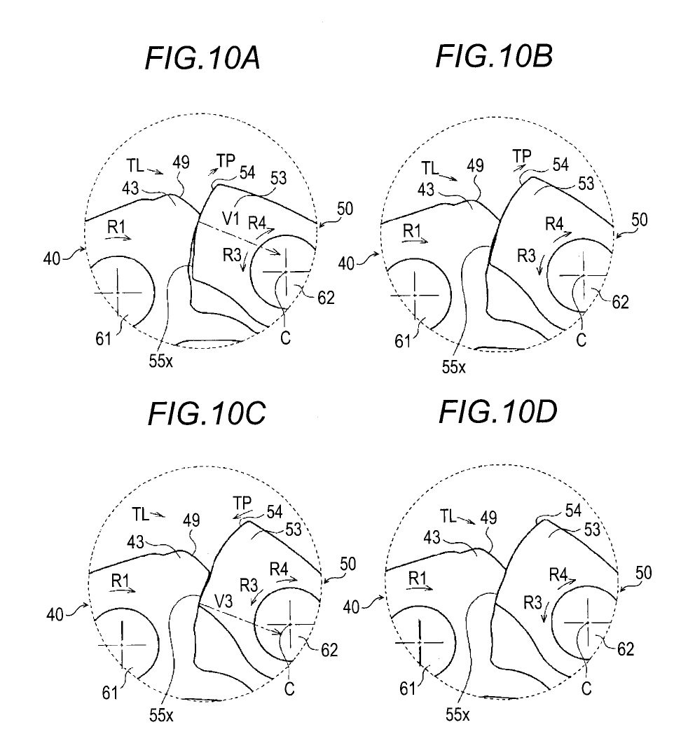

The effects of this configuration are described with reference to FIGS. 10A to 10D.

FIGS. 10A to 10D are enlarged views of a contact portion between the latch 40 and the cam pawl 50. In FIGS. 10A to 10D, an arrow TL represents a direction of the torque of the latch 40, and an arrow TP represents a direction of the torque of the cam pawl 50.

As illustrated in FIGS. 10A and 10B, when the locked state (state in which the contact surface 48 of the latch 40 is in contact with the cam surface 54 of the cam pawl 50) is formed, and a large impact force is applied to the rear seat 10 in the forward direction, the latch 40 rotates in the first rotational direction R1. Therefore, the cam pawl 50 rotates in the fourth rotational direction R4. When this rotation progresses, as illustrated in FIG. 100, the restricting surface 55x, formed to be closer in the third rotational direction R3 than the cam surface 54, comes into contact with the contact surface 48 of the latch 40 instead of the cam surface 54. Since the normal line V3 of the restricting surface 55x runs toward a point that is offset from the center of the cam pawl shaft 62 toward the latch shaft 61, the force of the first protruding portion 43 of the latch 40, induced by contact between the contact surface 48 of the latch 40 and the restricting surface 55x, is applied to the restricting surface 55x of the cam pawl 50 in a direction toward the latch 40 rather than the cam pawl shaft 62. For this reason, torque toward the latch 40 is applied to the cam pawl 50, as illustrated in FIG. 10D, the rotation of the cam pawl 50 in the fourth rotational direction R4 is prevented, and the rotation of the latch 40 in the first rotational direction R1 is re-restricted. As a result, even if a large impact force is applied to the rear seat 10, the seat locking device 20 can reliably restrain the striker 100. Even if the restricting surface 55x is formed in such a manner that the distance LX between the restricting surface 55x and the central axis C of the cam pawl shaft 62 gradually increases in the fourth rotational direction R4, when the seat locking device 20 is configured to have a predetermined structure, it is possible to obtain the same effects. Even if the restricting surface 55x is formed in such a manner that the distance LX between the restricting surface 55x and the central axis C of the cam pawl shaft 62 gradually increases in the fourth rotational direction R4, it is possible to obtain the same effects.

In the embodiment, the striker 100 is attached to the vehicle body, and the seat locking device 20 is attached to the seatback 12; however, the attachment may be the other way around. That is, the seat locking device 20 may be attached to the vehicle body, and the striker 100 may be attached to the seatback 12.

In the embodiment, the latch shaft 61 is fixed to the base member 30; however, the latch shaft 61 may be fixed to the latch 40. Similarly, the cam pawl shaft 62 is fixed to the base member 30; however, the cam pawl shaft 62 may be fixed to the cam pawl 50.

The seat locking device 20 of the embodiment can be applied as a device fixing various vehicle seats such as a tumble seat, a space-up seat, an attachable and detachable seat, and a dive-down seat.

The seat locking device 20 of the embodiment has the following technical ideas.

### Supplementary Note 1

A vehicle locking device includes: a base member that has a base groove into which a striker fixed to one of a fixed member and a movable member is inserted, and is fixed to the other of the fixed member and the movable member; a latch that has a latch groove which can be engaged with and disengaged from the striker, is rotatably attached to the base member, and can rotate between a locked position, at which the latch restrains the striker in the base groove, and an unlocked position at which the latch releases the striker; and a cam pawl that is attached to the base member, can rotate between an allowable position, at which the cam pawl allows the latch to rotate between the locked position and the unlocked position, and a preventive position, at which the cam pawl prevents the rotation of the latch from the locked position to the unlocked position, and rotates from the preventive position to the allowable position when a locking release operation is performed. The cam pawl has a restricting surface that restricts the rotation of the latch in a direction toward the unlocked position by coming into contact with a contact surface of the latch, and a cam surface that rotates in a direction toward the preventive position, comes into contact with the contact surface as the latch rotates in the direction toward the locked position, rotates the latch in the direction toward the locked position, and restricts the rotation of the latch in the direction toward the unlocked position, and both the restricting surface and the cam surface are formed on the same circumferential surface. The cam surface is formed at a position that is separated further from the central axis of the rotation of the cam pawl than the restricting surface is.

### Supplementary Note 2

In Supplementary Note 1, the cam surface is formed in such a manner that the distance between the surface and the central axis of the cam pawl gradually increases.

### Supplementary Note 3

In Supplementary Note 1, the latch is biased to cause the protruding portion of the latch to approach the cam pawl, and the cam pawl is biased to cause the protruding portion of the cam pawl to approach the latch.

An aspect of this disclosure is directed to a vehicle seat locking device including: a base member that has a base groove into which a striker fixed to one of a fixed member and a movable member is inserted, and is fixed to the other of the fixed member and the movable member; a latch that has a latch groove which can be engaged with and disengaged from the striker, is rotatably attached to the base member, and can rotate between a locked position, at which the latch restrains the striker in the base groove, and an unlocked position at which the latch releases the striker; and a cam pawl that is attached to the base member, can rotate between an allowable position, at which the cam pawl allows the latch to rotate between the locked position and the unlocked position, and a preventive position, at which the cam pawl prevents the rotation of the latch from the locked position to the unlocked position, and rotates from the preventive position to the allowable position when a locking release operation is performed. The cam pawl has a restricting surface that restricts the rotation of the latch in a direction toward the unlocked position by coming into contact with a contact surface of the latch, and a cam surface that rotates in a direction toward the preventive position, comes into contact with the contact surface as the latch rotates in the direction toward the locked position, rotates the latch in the direction toward the locked position, and restricts the rotation of the latch in the direction toward the unlocked position, and both the restricting surface and the cam surface are formed on the same circumferential surface.

With this configuration, the cam pawl has both the function of restricting the rotation of the latch in the direction toward the unlocked position, and the function of rotating the latch in the direction toward the locked position. That is, the cam pawl has the functions of both the cam and the pawl of a vehicle seat locking device with a structure in the related art. As a result, it is possible to reduce the number of components. That is, the vehicle seat locking device can be configured to have a lower number of components than that of the vehicle seat locking device in the related art. For this reason, it is possible to reduce the size of the vehicle seat locking device from that of the vehicle seat locking device with the structure in the related art.

The vehicle seat locking device described above may further include a latch shaft that rotates relative to the base member, or is fixed to the base member; and a cam pawl shaft that rotates relative to the base member, or is fixed to the base member, in which the latch may include a bearing portion into which the latch shaft is inserted, and a protruding portion which protrudes from the bearing portion, and the contact surface may be formed in a side portion of the protruding portion of the latch, and in which the cam pawl may include a bearing portion into which the cam pawl shaft is inserted, and a protruding portion which protrudes from the bearing portion, and the cam surface and the restricting surface may be formed at a distal end of the protruding portion of the cam pawl.

In this configuration, when the contact surface of the side portion of the protruding portion of the latch comes into contact with the cam surface or the restricting surface at the distal end of the protruding portion of the cam pawl, the side portion of the protruding portion of the latch is engaged with the distal end of the cam pawl, and thus the rotation of the latch is restricted.

In the vehicle seat locking device described above, the restricting surface may be formed along a circular arched surface centered around a central axis of the cam pawl, or may be formed in such a manner that the distance between the restricting surface and the central axis of the cam pawl gradually increases toward the latch.

In this configuration, when the contact surface of the latch comes into contact with the restricting surface of the cam pawl, the force of the latch induced by contact therebetween is applied to the cam pawl in a direction toward a central axis C of the cam pawl, or in a direction toward the latch rather than the central axis C of the cam pawl. Therefore, torque is applied to the cam pawl such that the cam pawl rotates toward the latch, and the cam pawl is prevented from rotating in a direction in which the cam pawl is separated from the latch. Therefore, the rotation of the cam pawl in the direction, in which the cam pawl is separated from the latch, is restricted, and engagement between the latch and the cam pawl is maintained.

In the vehicle seat locking device, the cam surface may be formed at a position that is separated further from the central axis of the rotation of the cam pawl than the restricting surface.

In the vehicle seat locking device, the cam surface may be formed in such a manner that the distance between the cam surface and the central axis of the cam pawl gradually increases.

In the vehicle seat locking device, the latch may be biased to cause the protruding portion of the latch to approach the cam pawl, and the cam pawl may be biased to cause the protruding portion of the cam pawl to approach the latch.

It is possible to reduce the size of the vehicle seat locking device from that of the vehicle seat locking device with the structure in the related art.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle seat locking device comprising:
a base member that has a base groove into which a striker fixed to one of a fixed member and a movable member is inserted, and is fixed to the other of the fixed member and the movable member;
a latch that has a latch groove which can be engaged with and disengaged from the striker, is rotatably attached to the base member, and can rotate between a locked position, at which the latch restrains the striker in the base groove, and an unlocked position at which the latch releases the striker; and
a cam pawl that is attached to the base member, can rotate between an allowable position, at which the cam pawl allows the latch to rotate between the locked position and the unlocked position, and a preventive position, at which the cam pawl prevents the rotation of the latch from the locked position to the unlocked position, and rotates from the preventive position to the allowable position when a locking release operation is performed,
wherein the cam pawl has a restricting surface that restricts the rotation of the latch in a direction toward the unlocked position by coming into contact with a contact surface of the latch, and a cam surface that rotates in a direction toward the preventive position, comes into contact with the contact surface as the latch rotates in a direction toward the locked position, rotates the latch in the direction toward the locked position, and restricts the rotation of the latch in the direction toward the unlocked position, and both the restricting surface and the cam surface are formed on the same circumferential surface.

2. The vehicle seat locking device according to claim 1, further comprising,
a latch shaft that rotates relative to the base member, or is fixed to the base member; and
a cam pawl shaft that rotates relative to the base member, or is fixed to the base member,
wherein the latch includes a bearing portion into which the latch shaft is inserted, and a protruding portion which protrudes from the bearing portion, and the contact surface is formed in a side portion of the protruding portion of the latch, and
wherein the cam pawl includes a bearing portion into which the cam pawl shaft is inserted, and a protruding portion which protrudes from the bearing portion, and the cam surface and the restricting surface are formed at a distal end of the protruding portion of the cam pawl.

3. The vehicle seat locking device according to claim 1,
wherein the restricting surface is formed along a circular arched surface centered around a central axis of the cam pawl, or is formed in such a manner that the distance between the restricting surface and the central axis of the cam pawl gradually increases toward the latch.

4. The vehicle seat locking device according to claim 1,
wherein the cam surface is formed at a position that is separated further from the central axis of the rotation of the cam pawl than the restricting surface is.

5. The vehicle seat locking device according to claim 4,
wherein the cam surface is formed in such a manner that the distance between the cam surface and the central axis of the cam pawl gradually increases.

6. The vehicle seat locking device according to claim 4,
wherein the latch is biased to cause the protruding portion of the latch to approach the cam pawl, and the cam pawl is biased to cause the protruding portion of the cam pawl to approach the latch.
